(19) United States
(12) Patent Application Publication
(10) Pub. No.: US 2003/0024523 A1
(43) Pub. Date: Feb. 6, 2003

(54) Barbecue grill

(75) Inventor: Hsu Ching-Hui, Taipei (TW)

Correspondence Address: BACON & THOMAS, PLLC, 625 SLATERS LANE, FOURTH FLOOR, ALEXANDRIA, VA, 22314

(73) Assignee: Test-Rite Products Corporation, Buena Park, CA

(21) Appl. No.: 09/920,844

(22) Filed: Aug. 3, 2001

(51) Int. Cl. A47J 37/00

(52) U.S. Cl. 126/25 R; 126/245

(57) ABSTRACT

The present invention relates to a grill comprising a grill body and two grill lids; the upper part of the grill body is wide-open to contain grill grids, which both grill lids fully cover, with charcoal placed inside the grill and burned at the bottom of the grill lids' covered space. In addition, the barbecue grill with two grill lids allows the user to cook the food items at one side of the grill with the lid on top closed, thus achieving the smoldering effect on the food items, and at the same time, cook the food items at the other side of the grill with the lid on top opened, thus enabling the user to turn the food items over. Therefore, with the design of the present invention, the grill can prevent heat from dispersing, improve the grill efficiency, and enable the user to cook the food items with different ways of cooking simultaneously.

### BACKGROUND OF THE INVENTION

1. Field of the Invention

The present invention relates to a barbecue grill comprising a grill body and two grill lids; the upper part of the grill body is wide-open to contain a grill grid, which both grill lids fully cover. The present invention enables the two lids of the grill to be operated independently, thus forming the heat-preserving spaces respectively and improving the efficiency for smoldering food items.

2. Description of the Related Art

Holding barbecue parties has already become one of the most popular outdoor activities for people during the holidays, and the most commonly used barbecue tool is the grilling grid, for it is easy to carry; yet the user still needs rocks or bricks to support the grilling grid for the purpose of air convection. Therefore, it is often tedious and troublesome searching for useful rocks or bricks. Besides, with no covering function, the grilling grid is unable to effectively prevent the heat from dispersing, and prevent the food items from being exposed to the outside environment, thus causing sanitary problems. Even if the grilling grid is used indoors, the stains caused by directly burning charcoal on the floor are difficult to clean, and the smoke and dust permeating in the interior also raise health concerns.

Therefore, for the purpose of removing the inconvenience and defects of the grilling grid, the prior art provides the design of a barbecue grill, wherein a chamber-like structure is formed to contain burning charcoal, thus keeping the environment clean and containing the burned ashes. The design of grill lids also prevents the heat from dispersing and keeps the food items from being exposed to the outside environment. However, according to the grill design of the prior art, the grill and the grill lid are separate structures, and the user can only fully open the grill or fully cover the grill; so when in use, the user must completely open the grill lid to turn the food items over, while causing heat-dispersion for other food items, like corn and yams, that need to be smoldered for a period of time. In addition, with the design of the grill and the grill lid being separate structures, it is difficult to keep the grill lid intact through numerous storage processes. FIG. 1 shows the frontal side view of a common barbecue grill 1. Based upon the prior art, the barbecue grill 1 comprises a grill body 10, grill grid 11, and a grill lid 12, wherein the grill body 10, forming a chamber-like shape with the top wide-open, is supported by three supporting legs 101, 102, and 103 to stabilize the grill body 10 for easy operation, on top of which the grill grid is installed for the user to place food items on, and charcoal can be placed underneath the grill grid inside the grill body to be burned. The grill lid 12 can be used to cover both the grill body 10 and the grill grid 11, so that the food items can be efficiently cooked without dispersing the heat.

Nevertheless, the foregoing barbecue grill 1 of the prior art only contains a single grill lid 12 with only two functions, fully open and fully close. As a result, when the user cook different kinds of food needing varying periods of time to cook, the user must open the grill lid 12 to turn over certain kinds of food items needing only shorter periods of time to cook, while the heat kept inside the grill body 10 is dispersed because of the grill lid 12 being opened. Thus other kinds of food items that need more time to cook shall not be timely ready. Consequently, with the user opening and closing the grill lid 12 repeatedly, the purpose and function of the grill lid 12 are totally unfulfilled.

### SUMMARY OF THE INVENTION

The primary object of the present invention is to provide a barbecue grill with grill lids, comprising a grill body and two grill lids; the grill body is formed with the top wide-open and with the grill grid installed thereon, and the two grill lids fully cover the grill grid, with charcoal burned at the bottom of the space covered by the grill lids. The design of the present invention, with two grill lids respectively covering two closed heat-preserving spaces, enables the user to smolder on one side the kinds of food items that need more time to cook, and turn over on the other side the kinds of food items that need less time to cook, thus preventing the heat from dispersing, and at the same time expediting the process of preparing different kinds of food items that need varying periods of time to cook.

### BRIEF DESCRIPTION OF THE DRAWINGS

These and other features, aspects and advantages of the present invention will become better understood with regard to the following description, appended claims and accompanying drawings where:

FIG. 1 is a frontal side view of a barbecue grill of the prior art;

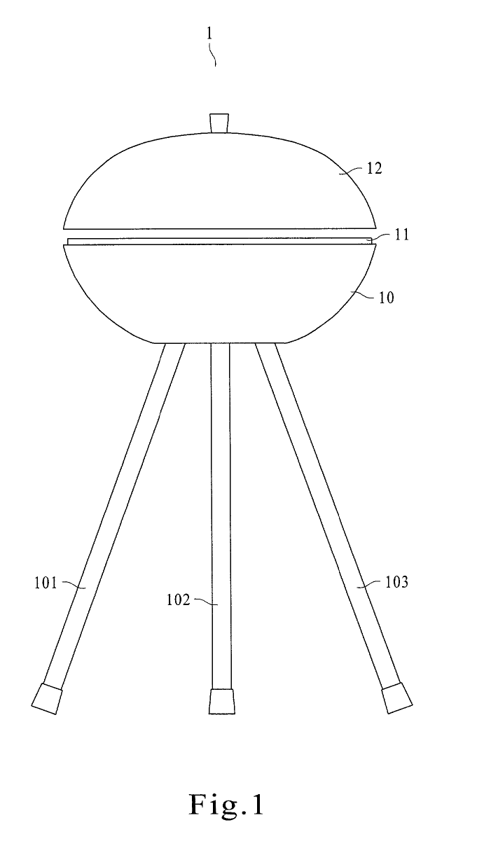

FIG. 2 is a structural perspective view of a barbecue grill embodying features of the present invention;

FIG. 3 is another structural perspective view of a barbecue grill embodying features of the present invention;

FIG. 4 is a left side view of a barbecue grill embodying features of the present invention;

FIG. 5 is a top plan view of a barbecue grill embodying features of the present invention; and

FIG. 6 is a frontal side view of a barbecue grill embodying features of the present invention.

### DETAILED DESCRIPTION OF THE PREFERRED EMBODIMENTS

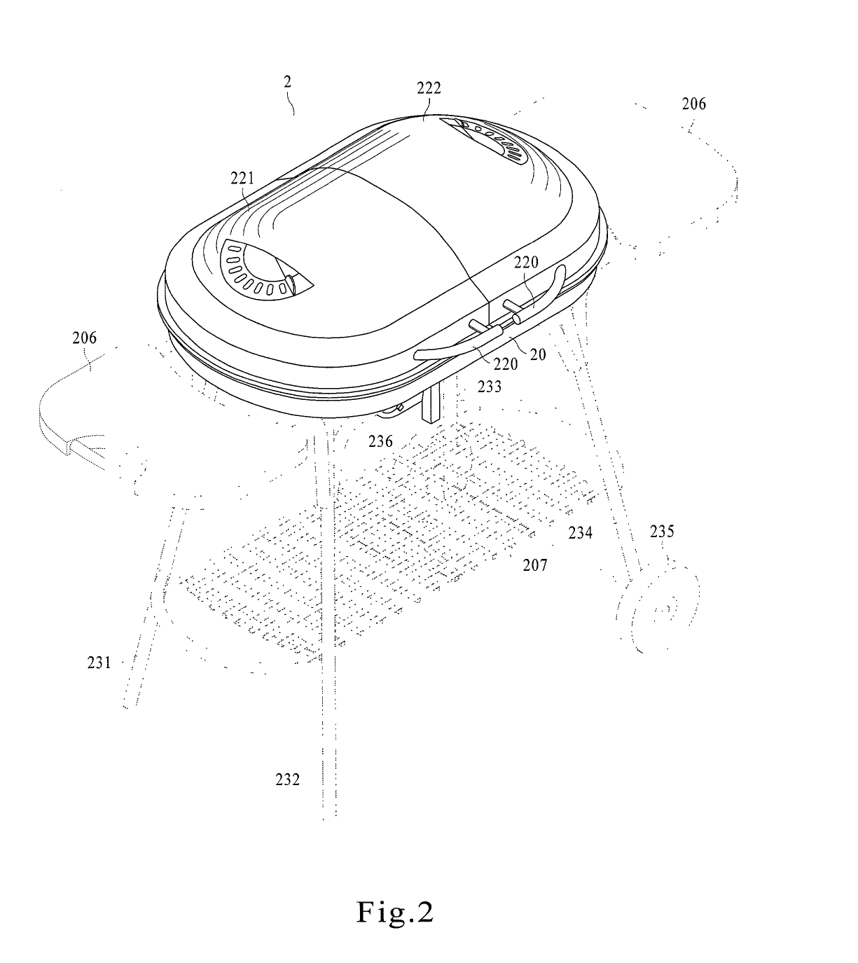

As shown in FIG. 2, the barbecue grill 2 comprises a grill body 20, a grill grid 21, and grill lids 221 and 222; the grill body 20 is formed as a chamber-like shape with the top wide-open, whereon the grill grid 21 is installed as a food-supporting operational platform, and charcoal is placed underneath the grill grid 21 at the bottom of the inside of the grill body 20. At the lower part of the grill body 20, four supporting legs are joined to the grill body 20 to stabilize the barbecue grill 2, thus the food items placed on the grill grid 21 are not to be accidentally moved.

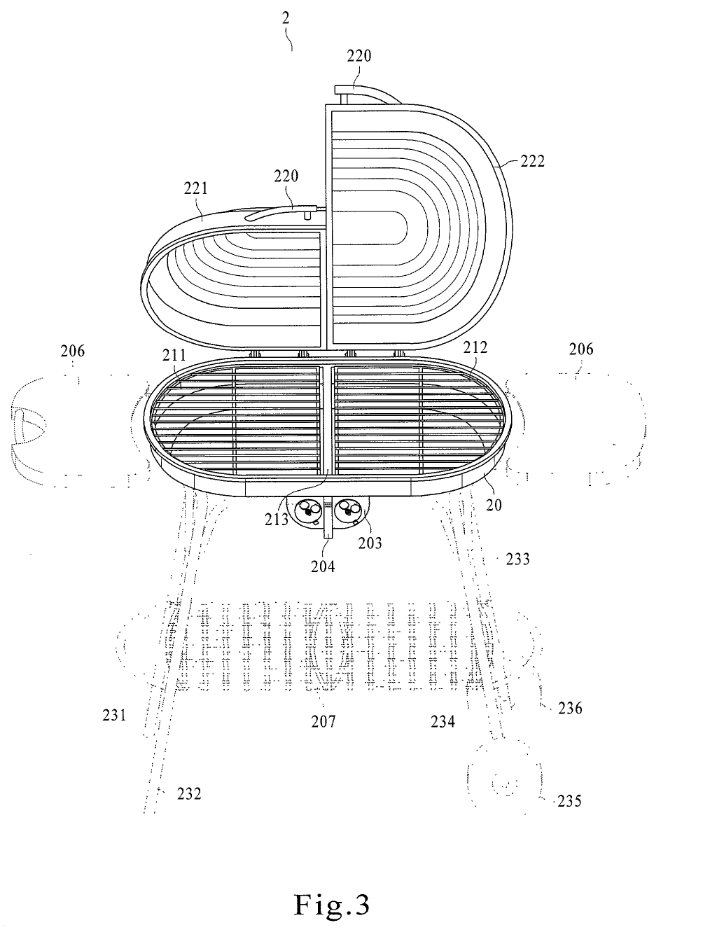

As shown in FIG. 2 and FIG. 3, the grill body 20 and the grill grid 21 are to be divided into at least two sections by dividers, forming the cooking sections 211 and 212, shown in FIG. 2 and FIG. 3, with at least one section covered by grill lid, as shown in FIG. 2 and FIG. 3, the cooking sections 211 and 212 are respectively covered by grill lids 221 and 222. The food items can be sorted and placed according to various periods of cooking time. For example, the food items that need to be smoldered are to be placed and smoldered at cooking section 211 covered with grill lid 221 without dispersing the heat needed; another cooking section 212, with the grill lid 222 opened, can be used to cook food items that need shorter periods of time to cook and need to be turned over regularly to avoid being overcooked. As a result, the heat-preserving effect in the cooking section 211 is not decreased by the repeated opening of the grill lid 222 of the cooking section 212, and various food items needing different periods of time to cook can be cooked at the same time.

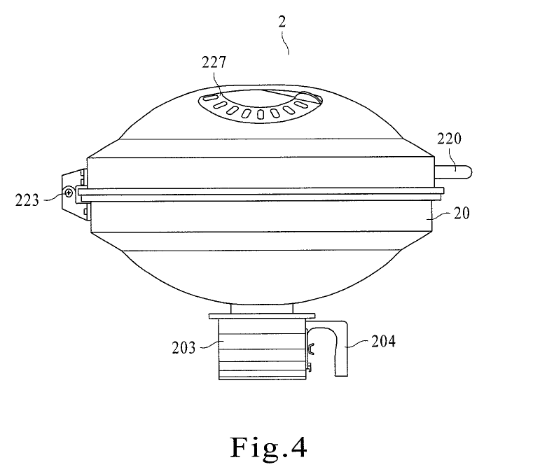

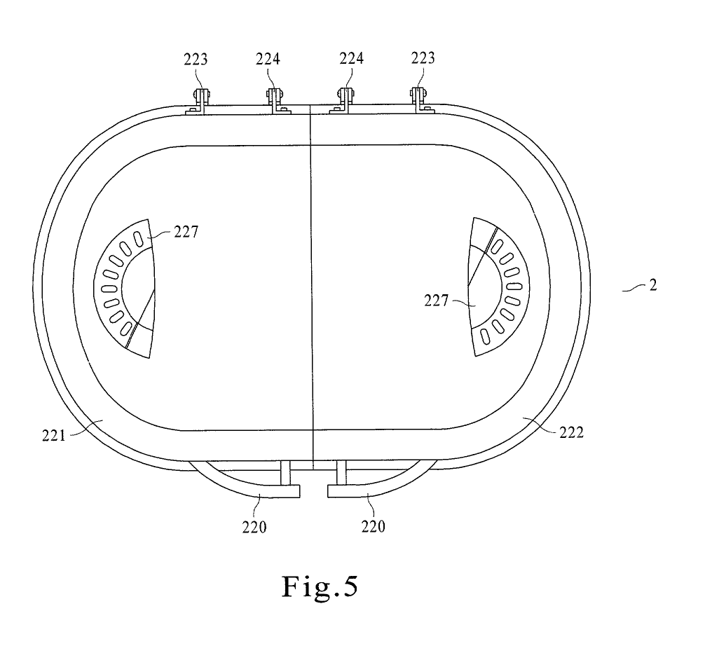

The detailed description of the grill lid 221 is as follows, as shown in FIG. 4 and FIG. 5, wherein a handle 220 is installed at the front side of the grill lid 221, preventing the user from being burned by opening and closing the grill lid 221. The grill lid 221 is joined to the grill body 20 by shafts 223 and 224, which are used as rotating shafts when the grill lid 221 is opened and closed. An air hole 227 is installed on the grill lid 221, so that the heat generated by burning can be emitted via the air hole 227 and the pressure can be released, thus preventing the interior of the grill body 20 from being over-pressured.

The structural designs and functions of the grill lid 222 are identical to those of the grill lid 221.

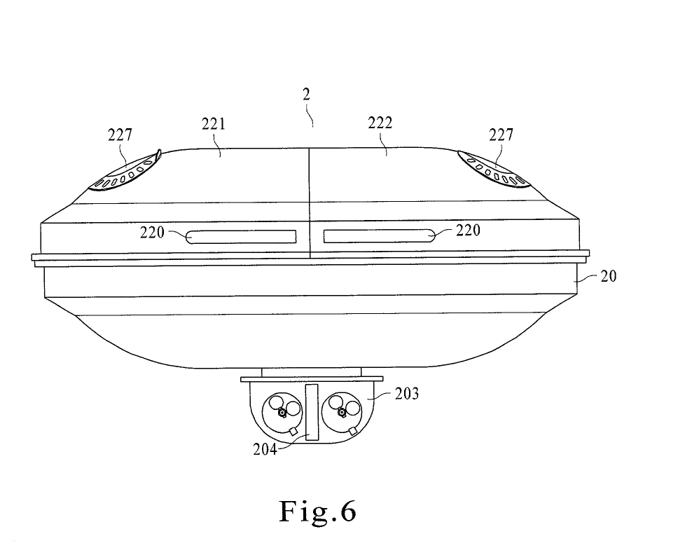

FIG. 3 and FIG. 6 show the details of the grill body 20 in the barbecue grill 2 of the present invention; at the outer bottom of the grill body 20 contains an ash-collecting vessel 203, wherein a retrieving drawer 204 is installed inside the ash-collecting vessel and can be pulled and retrieved from the front side of the grill body 20. In addition, at the inner bottom of the grill body 20, a burning grid is installed, whereon fuel like charcoal can be placed and burned, with all the ashes after burning fall directly into the retrieving drawer 204 inside the ash-collecting vessel 203, and then the user can pull out the retrieving drawer 204 and dispose of the ashes.

As shown in the dotted portion of FIG. 2 and FIG. 3, the tables 206 are further installed at both left and right sides of the grill body 20 in the barbecue grill 2, and a rack 207 is installed in the space surrounded by the four supporting legs 231, 232, 233, and 234, for the purpose of placing food items and barbecue sauces, etc. In addition, the present invention can further embody the features of two wheels 235 and 236 installed at the end of two supporting legs, such as supporting legs 231 and 232 for the purpose of moving the barbecue body 2 conveniently.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

What is claimed is:

1. A barbecue grill, comprising:
a grill body, forming a chamber-like shape with the top wide-open, wherein at the bottom of a concave a burning chamber can be formed to contain fuel such as charcoal, providing the heat needed for grilling and smoldering food items;
a grill grid, attached on top of said concave in said grill body, can be used to place food items ready to be grilled and smoldered; and
two grill lids, installed on top of said grill body, covers said grill grid completely with said grill lids able to be covered respectively, thus forming two heat-preserving spaces.

2. A barbecue grill as in claim 1, wherein multiple grill lids are installed, and by dividing devices said grill body and said grill grid are divided into a number of sections identical to the number of said grill lids, thus every said grill lid can cover respectively each said section formed by each part of said grill body and said grill grid, and form heat-preserving spaces.

3. A barbecue grill as in claim 1, wherein said grill body is divided into two sections in accordance with the positions of said grill lids, such that the user can control the temperature in each said section of said grill body by controlling the quantity of fuel and covering time by said grill lids.

4. A barbecue grill as in claim 1, wherein said grill lids are joined to said grill body by shafts, with multiple bolts in said shafts being used as rotating shafts for opening and closing said grill lids.

5. A barbecue grill as in claim 1 or claim 2, wherein multiple air holes are further installed on said grill lids to release the pressure of hot air produced by burning.

6. A barbecue grill as in claim 1, wherein at the outer bottom of said grill body further contains an ash-collecting vessel, wherein a retrieving drawer is installed inside said ash-collecting vessel and can be pulled and retrieved from the front side of said grill body; in addition, at the inner bottom of said grill body, a burning grid is installed on top of said ash-collecting vessel, so that fuel such as charcoal can be placed and burned on said burning grid, with all the ashes therefrom falling directly into said retrieving drawer inside said ash-collecting vessel.

7. A barbecue grill as in claim 1, claim 2, or claim 6, wherein four supporting legs are further installed under said grill body, and multiple wheels are installed at the free ends of two said supporting legs at one side at least.

8. A barbecue grill, comprising:
a grill body, forming a chamber-like shape with the top wide-open, wherein at the bottom of a concave a burning chamber can be formed to contain fuel such as charcoal, providing the heat needed for grilling and smoldering food items;
a grill grid, attached on top of said concave in said grill body, can be used to place food items ready to be grilled and smoldered;
two grill lids, installed on top of said grill body, covers said grill grid completely with said grill lids able to be closed respectively thus forming two heat-preserving spaces;
an ash-collecting vessel, further installed at the outer bottom of said grill body, so that all of the ashes from fuel burned fall directly into said ash-collecting vessel;
a plurality of supporting legs, installed under said grill body, with wheels installed at the free ends of two said supporting legs at one side;
a plurality of tables, installed at both left and right side of said grill body, for the purpose of placing the food items, barbecue sauces, charcoal, and other barbecue materials; and
a rack, installed under said grill body and fixed with said supporting legs, for placing ready-to-use materials, charcoal, or other tools.
